(19) United States
(12) Patent Application Publication
(10) Pub. No.: US 2026/0252977 A1
(43) Pub. Date: Aug. 27, 2026

(54) SYSTEM AND METHOD FOR INTELLIGENT CORPORATE TRAVEL MANAGEMENT

(71) Applicant: WNS Global Services Private Limited, Gurugram (IN)

(72) Inventor: Siddharth GANDHI, Gurgaon (IN)

(73) Assignee: WNS Global Services Private Limited, Gurugram (IN)

(21) Appl. No.: 19/410,679

(22) Filed: Dec. 5, 2025

(30) Foreign Application Priority Data
Feb. 24, 2025 (IN) 202511016041

(51) Int. Cl. G06Q 10/02; G06Q 50/12; G06Q 50/14

(52) U.S. Cl. CPC G06Q 10/02; G06Q 50/12; G06Q 50/14

(57) ABSTRACT

The present disclosure provides an artificial intelligence based corporate travel management system that automates end-to-end processes for booking, modifying, and managing corporate travel across air, hotel, and ground transport. The system leverages Generative AI / NLP for understanding and classifying booking requests received via email, chatbot, and an online portal. The system optimizes travel recommendations based on corporate policies and traveler preferences, ensuring policy compliance and customization. The system performs automated itinerary generation, expense categorization from scanned documents, and real-time travel advisories. The system interfaces with third-party platforms to provide customized recommendations.

### CROSS-REFERENCE TO RELATED APPLICATIONS

This patent application claims priority from Indian patent application no. 202511016041, filed on February 24, 2025, the entire disclosure of which is incorporated herein by reference.

### TECHNICAL FIELD OF THE INVENTION

The present invention relates generally to relates to travel booking-related requests, and in particular, a method and system employing generative Artificial Intelligence (AI) for managing travel booking-related requests.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the overall field of the disclosure, and not as admissions of prior art.

Travel is an integral and critical aspect of business operations in the corporate sector, which, given the volume, frequency, and complexity, necessitates the requirement of complex, yet efficient systems for managing such travel requests, including booking, managing, and claiming travel requests, including related expenses. However, existing travel management solutions suffer from a lack of full integration and automation, requiring travelers and operational agents to navigate separate tools and processes. Traditionally, corporate travel booking requires employees to initiate travel requests through form-based, workflow-driven portals that have limited integration capabilities and where fulfilment support is provided by travel desk agents. These solutions are typically not optimized for mobile use, forcing users to rely on laptops or desktops to make requests, approve itineraries, or adjust bookings. This inflexibility hampers on-the-go travel planning, particularly for last-minute changes and automated fulfilment.

Moreover, existing platforms lack personalized features, which may consider an individual’s travel history and preferences, resulting in generic itinerary options that do not cater to the unique needs of frequent travelers. Additionally, booking flights and hotels often involves multiple teams and systems, complicating the whole process and creating redundancies. Expense claim workflows are also cumbersome, requiring users to manually store, submit, and manage receipts, often leading to issues with lost or degraded receipts, making expense claims tedious and error-prone.

Although some workflow-based systems offer partial integration with policy data, user profiles, and billing platforms, they are limited in their functionality. They are unable to process unstructured requests (e.g., from emails or chat messages). These limitations in existing solutions lead to significant inefficiencies, delays, and user frustration in corporate travel management.

In light of the above, there is a need for an advanced, fully integrated, end-to-end solution that can adapt to user preferences, automate booking, and streamline expense claims in real time.

### SUMMARY OF THE INVENTION

This section is provided to introduce certain objects and aspects of the present disclosure in a simplified form that are further described below in the description. This summary is not intended to identify the essential features of the disclosure nor is it intended for use in determining or limiting the scope of the claimed subject matter.

In an aspect of the present invention, there is provided a method for managing travel booking-related requests by a user. The method includes receiving by a server system at least one travel booking-related request via at least a channel; updating an existing travel case or creating a new travel case by the server system on a workflow platform based on the at least one travel booking- related request received by the server system; retrieving by the server system one or more available options for the travel booking-related request from at least a third-party; and ranking and displaying by the server system the retrieved one or more available options based on a profile of the user.

In an aspect, the method includes booking by the server system at least one of the retrieved options based on user selection.

In an aspect, the at least one travel booking related request can be one or more of a new booking request, a cancellation request, an exchange request, an invoice request, and an expense logging request.

In an aspect, the at least one travel booking can be at least one or more of air travel, ground travel, and stay/hotel booking.

In an aspect, the channel is selected from the group consisting of email, chat box, online portal, and combinations thereof.

In another aspect, the method, upon receiving by the server system the at least one travel booking related request, includes identifying and extracting by the server system via implementation of a generative artificial intelligence (AI) model, relevant data fields related to the at least one travel booking related request.

In another aspect, the method, upon retrieving by the server system the one or more available options, includes validating the one or more available options by the server system based on at least a pre-existing rule for compliance; and optionally, applying by the server system, at least a tag to the one or more available options to indicate compliance or non-compliance.

In yet another aspect, the method includes scraping by the server system at least a web-based source at a pre-defined interval to collect information related to travel disruption; and notifying the user about disruption based on user booking.

In yet another aspect, the method includes generating by the server system at least a log; and tagging by the server system the at least the log with the booking.

In yet another aspect, one or more steps of the method are executed by at least one processor comprising at least one module.

In another aspect of the present invention, there is provided a system for managing travel booking-related requests by a user, the system comprising a server system, said server system comprising at least a first module that is an input/output (I/O) module to receive least one travel booking-related request via at least a channel; at least a second module that is a workflow platform module to update an existing travel case or create a new travel case based on the at least one travel booking-related request received by the first module; includes at least a third module that is a fetch module to retrieve one or more available options for the travel booking-related request from at least a third-party; and at least a fourth module that is a ranking module to rank the retrieved one or more options based on a profile of the user, and display the ranked one or more available options by the first module.

In an aspect, the server system comprises at least a fifth module that is a booking module to book at least one of the displayed ranked one or more options based on user selection.

In another aspect, the at least one travel booking-related request can be one or more of a new booking request, a cancellation request, an exchange request, an invoice request, and an expense logging request.

In another aspect, the at least one travel booking can be at least one or more of air travel, ground travel, and stay/hotel booking.

In an aspect, the channel is selected from the group consisting of email, chat box, online portal, and combinations thereof.

In an aspect, at least the second module that is the workflow platform module, upon receiving from at least the first module the at least one travel-booking related request, identifies and extracts, via implementation of a generative artificial intelligence (AI) model, relevant data fields related to the at least one travel booking related request.

In an aspect, the server system includes at least a sixth module that is a validation module to validate the one or more available options retrieved by at least the third module, based on at least a pre-existing rule for compliance; and optionally, apply at least a tag to the one or more available options to indicate compliance or non-compliance.

In an aspect, the server system includes at least a seventh module that is a scraper module to collect information related to travel disruption from at least a web-based source at a pre-defined interval; and notify the user about the travel disruption based on user booking.

In an aspect, the server system includes at least an eighth module configured to generate at least a log; and tag at least the log with the booking.

In an aspect, any one or more of the modules are at least a single or a plurality of modules comprising at least a processor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an environment related to an embodiment of the present disclosure.

FIG. 2 illustrates an exemplary block diagram of a system for managing travel booking-related requests, in accordance with an embodiment of the present disclosure.

FIG. 3 illustrates a flowchart of a method for managing travel booking-related requests, in accordance with an embodiment of the present disclosure.

The foregoing shall be more apparent from the following more detailed description of the disclosure.

### DETAILED DESCRIPTION OF THE INVENTION

In the following description, for the purposes of explanation, various specific details are set forth in order to provide a thorough understanding of the embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, a “processor” or “processing unit” includes one or more processors, wherein processor refers to any logic circuitry for processing instructions. A processor may be a general-purpose processor, a special-purpose processor, a conventional processor, a digital signal processor, a plurality of microprocessors, one or more microprocessors in association with a DSP core, a controller, a microcontroller, a low-end microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “connect,” “configure,” “couple,” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send,” “transfer,” “transmit,” and their cognate terms like “sending,” “sent,” “transferring,” “transmitting,” “transferred,” “transmitted,” etc. include sending or transporting data or information from one unit or component to another unit or component, wherein the content may or may not be modified before or after sending, transferring, transmitting.

As used herein, “database” “memory unit,” “storage unit” and/or “memory” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media.

As used herein ‘computer readable media’ refers to both volatile and non-volatile media, removable and non-removable media, any available medium that may be accessed by the computing device. By way of example and not limitation, computer readable media comprise computer storage media and communication media.

Hereinafter, exemplary embodiments of the present disclosure will be described in detail with reference to the accompanying drawings so that those skilled in the art can easily carry out the present disclosure.

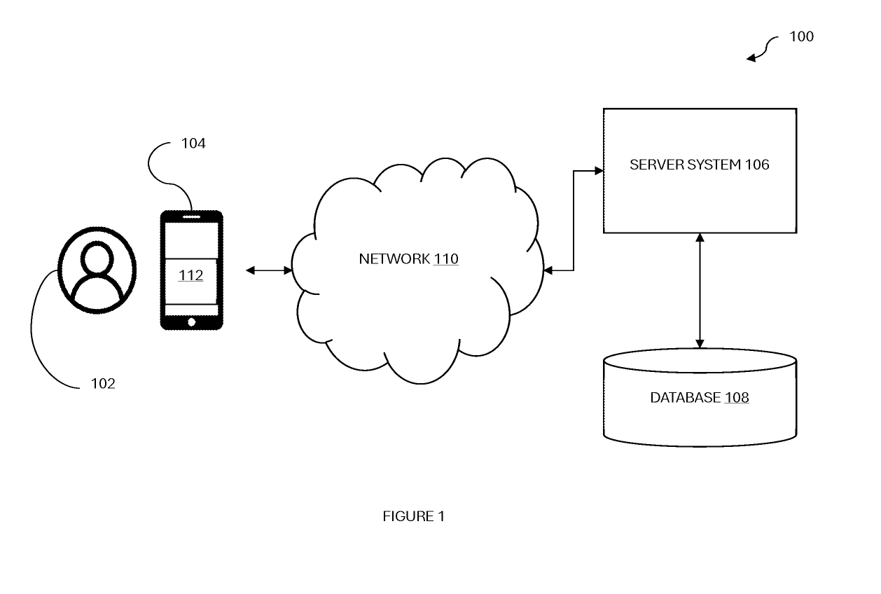

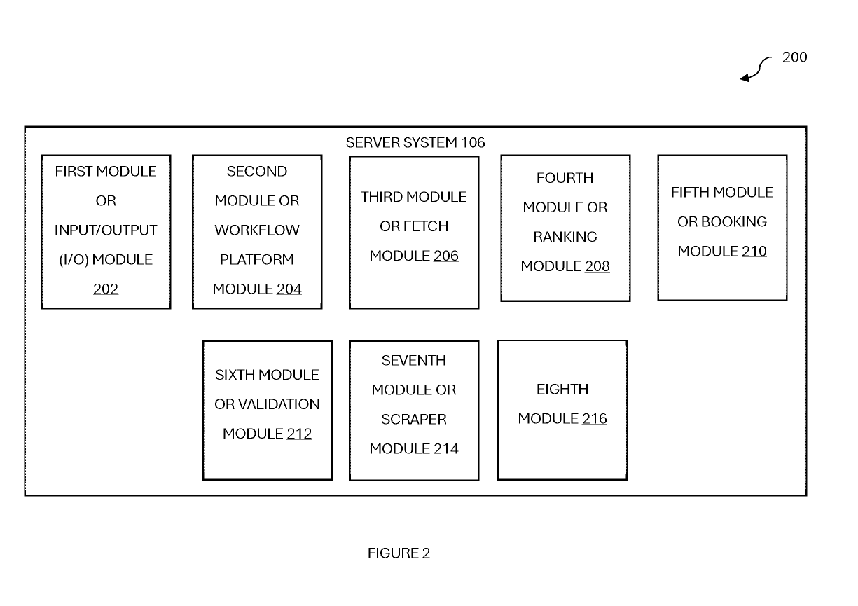

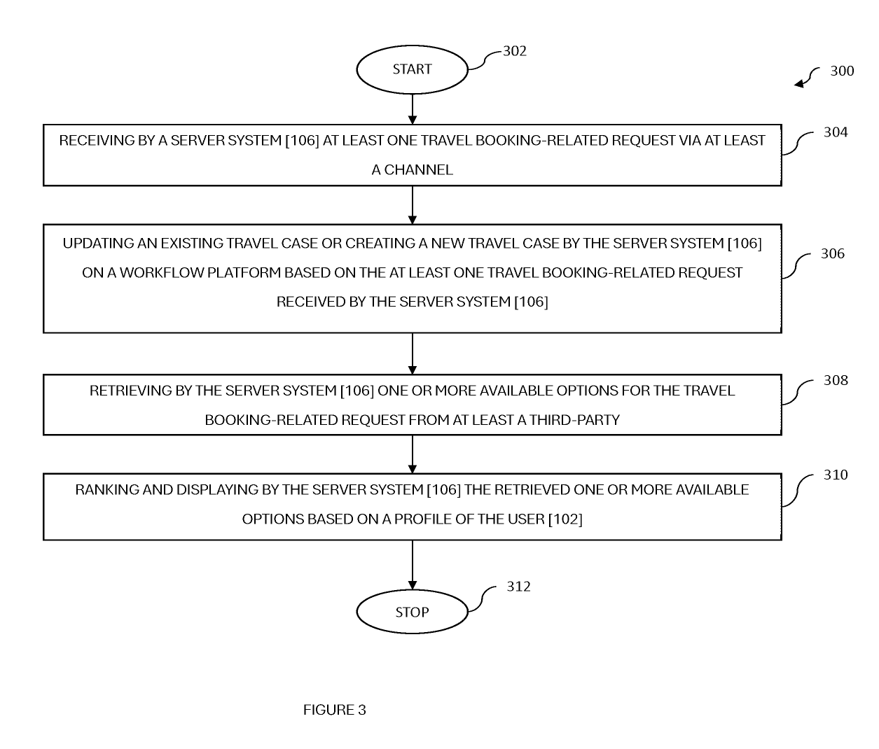

FIG. 1 illustrates an environment [100] related to an embodiment of the present disclosure. It should be understood that the environment [100], illustrated and hereinafter described, is merely illustrative of an arrangement for describing some exemplary embodiments, and therefore, should not be taken to limit the scope of the embodiments. As such, it should be noted that at least some of the components described below in connection with the environment [100] may be optional and thus in some embodiments may include more, less, or different components than those described in connection with subsequent FIGS. 2 and 3.

The environment [100] generally depicts a device [104] associated with a user [102], a server system [106], a database [108] associated with the server system [106], and a travel booking application [112], connected by a communication network, such as a network [110]. In one implementation, the travel booking application [112] is installed in the device [104].

Various entities in the environment [100] may connect to the network [110] in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof.

For example, the network [110] may include multiple different networks, such as a private network made accessible by the server system [106] and a public network (e.g., the Internet, etc.) through which the server system [106] may communicate.

The user [102] may correspond to any individual, organization, representative of a corporate entity, a non-profit organization, or any other person who accesses the travel booking application [112] on the device [104] to facilitate the planning, booking, modifying, and managing of travel arrangements and related services. In some examples, the user [102] may be a corporate employee, a contractor, an executive, or any other person authorized by an entity (e.g., business, organization, etc.) to arrange and manage travel related requests. In one example, the user [102] may be an individual authorized to manage travel booking for a corporate entity.

In one example, the user [102] may interact with the travel booking application [112] to book various travel services such as flights, accommodations, ground transportation, or other travel-related services. The user [102] may perform various actions including, for example, but not limited to initiating new travel bookings, adjusting, or cancelling existing bookings, reviewing recommended itineraries, and submitting expense claims. In one embodiment, the user [102] runs the travel booking application [112] on the device [104] with facilitation of a network, such as the network [110].

In an embodiment, the user [102] accesses the travel booking application [112] as a software application installed in the device [104]. In another embodiment, the user [102] accesses the travel booking application [112] as a web application. The web application can be accessed via a web browser installed in the device [104].

The device [104] is associated with the user [102]. In one embodiment, the device [104] may correspond to any suitable electronic or computing device. In some examples, the device [104] may correspond to a smartphone, a personal computer, a laptop, a personal digital assistant (PDA), an electronic tablet, a desktop computer, a smart device such as smart TV or smart appliance, a smartwatch, etc., among other suitable electronic devices.

The travel booking application [112] may refer to a software platform designed to facilitate end-to-end management of corporate travel arrangements and expense logging. The travel booking application [112] enables the user [102] to initiate, modify, and manage travel bookings, including flights, accommodations, and ground transportation, in a seamless and efficient manner. The travel booking application [112] serves as a centralized interface where users (e.g., the user [102]) can interact with various travel-related services and tools.

In one example, the user [102] may download and/or install the travel booking application [112] from the server system [106]. In another example, the user [102] may download and/or install the travel booking application [112] from a remote server (not shown in figures).

In an embodiment, the server system [106] is deployed as a standalone server or can be implemented in cloud as software as a service (SaaS). In another embodiment, the server system [106] is deployed as a distributed server. In an embodiment, the server system [106] provides or hosts the travel booking application [112]. In an embodiment, the travel booking application [112] is executed in the device [104].

In an embodiment, an instance of the travel booking application [112] is accessible in the device [104]. In an embodiment, another instance of the travel booking application [112] is accessible in the server system [106]. For example, the travel booking application [112] may correspond to front-end or client side and the server system [106] may correspond to back end or server side.

In one implementation, the travel booking application [112] connects with the server system [106] with facilitation of the network [110].

In an embodiment, the server system [106] is configured to process structured inputs, such as form-based requests. In another embodiment, the server system [106] is configured to process unstructured inputs, such as email or chat-based requests.

In addition, the server system [106] incorporates advanced artificial intelligence (AI) and machine learning algorithms to analyze user profiles, travel history, preferences, and corporate travel policies. Also, the server system [106] recommends personalized itineraries, facilitate quick changes to bookings, and automate expense claims, minimizing the need for manual processes and reducing administrative overhead.

Moreover, the server system [106] integrates with third-party systems, such as ticketing platforms, billing systems, and organizational databases, to provide real-time availability and booking confirmation. The server system [106] also complies with corporate travel policies, ensuring that all bookings are in line with company guidelines.

Initially, the server system [106] is configured to receive at least one travel booking-related request via at least a channel. In an embodiment, the at least one travel booking-related request can be one or more of a new booking request, a cancellation request, an exchange request, an invoice request, and an expense request. In addition, the at least one travel booking can be at least one or more of air travel, ground travel, and stay/hotel booking.

In an embodiment, the channel is selected from the group consisting of email, chat box, online portal, and combinations thereof. For example, a user (e.g., the user [102]) may fill a form on the travel booking application [112]. In an example, the form may include a dropdown menu or radio buttons to select one of new booking request, cancellation request, update request, invoice request, and expense report request.

In addition, the form may include a dropdown menu or checkbox options to select at least one of air travel, ground travel, hotel booking, etc. The form may include text boxes to enable the user [102] to enter travel information (such as departure date, return date, destination, preferred airline, hotel name, etc.), traveler information (such as full name, email address, contact details, etc.), invoice information (such as billing address, payment method, etc.), and the like.

Once the server system [106] receives the travel booking-related request from the user [102], the server system [106] is configured to update an existing travel case or create a new travel case on a workflow platform. In an embodiment, the workflow platform is integrated into the user interface (UI) of the travel booking application [112]. In another embodiment, the workflow platform is integrated into the server system [106].

In case the travel booking-related request is a new booking request, the server system [106] is configured to create a new travel case on the workflow platform in the travel booking application [112]. In case the travel booking-related request is any other request, the server system [106] is configured to update the existing travel case on the workflow platform in the travel booking application [112]. In one implementation, the new booking request may also include a modification request for an existing booking.

Next, the server system [106] is configured to retrieve one or more available options for the travel booking-related request from at least a third-party. In an embodiment, the third-party is a travel booking server (e.g., ground travel, air travel, etc.). In another embodiment, the third-party is a hotel booking server. Further, the server system [106] is configured to rank and display the retrieved one or more available options based on a profile of the user [102].

The profile of the user [102] may store demographic information (e.g., full name, date of birth, gender, contact information, etc.), payment information (e.g., saved payment methods, billing address, etc.), travel preference (such as preferred travel class (e.g., economy, business, etc.), meal preference (e.g., vegetarian, gluten-free, etc.), seat preference (e.g., aisle, window, etc.), frequent destinations (for personalized recommendations), and preferred airlines, hotels, or car rental services.

The profile of the user [102] may also store booking history (such as previous trips (e.g., destinations, travel dates, accommodations, etc.)), travel companions (e.g., family members, business associates, etc.), and the like. Moreover, the profile of the user [102] may store accessibility needs (e.g., wheelchair access, service animal accommodations, etc.), language preferences, and saved documents (e.g., passport information, visa information, insurance details, etc.).

The database [108] may be adapted to store information, such as, but not limited to, profile of the user [102], metadata associated with the at least one travel booking-related request, and travel cases stored on the workflow platform. In addition, the database [108] may also include metadata and/or information associated with the travel booking application [112], and the like.

The database [108] is associated with the server system [106]. In some implementations, the database [108] can be accessed, viewed, managed, and/or updated with facilitation of a database management system (DBMS), relational database management system (RDBMS), or the like.

It is noted that the travel booking application [112] may include one or more interfaces (e.g., home screen, settings menu, chatbot screen, etc.). In addition, the placement of menus or buttons on each interface may be different.

The number and arrangement of systems, devices, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment [100] may perform one or more functions described as being performed by another set of systems or another set of devices of the environment [100].

FIG. 2 illustrates an exemplary block diagram [200] of a system for managing travel booking-related requests, in accordance with an embodiment of the present disclosure.

The system [200] includes the server system [106]. The server system [106] includes a computer system and a database (e.g., the database [108]). The computer system includes at least one processor, such as a processor for executing instructions, a memory, a communication interface, a bus, and a storage interface. The bus enables entities of the computer system to communicate with each other.

In an implementation, the database [108] may be integrated into the computer system, potentially utilizing hard disk drives. In another implementation, the database [108] may be external/remote to the computer system. The storage interface provides the processor with access to the database [108] through various adapter options.

It is noted that while the computer system is illustrated with a single processor (i.e., the processor), the computer system can potentially include multiple processors. The processor executes computer-readable instructions to perform operations related to travel booking management. Various processor options, such as application-specific integrated circuit (ASIC) processor, reduced instruction set computing (RISC) processor, complex instruction set computing (CISC) processor, field-programmable gate array (FPGA), and the like can be employed.

The storage interface is any component capable of providing the processor with access to the database [108]. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor with access to the database [108].

The memory stores the computer-readable instructions necessary for the processor. Examples of the memory include a random-access memory (RAM), a read-only memory (ROM), a removable storage drive, a hard disk drive (HDD), and the like. It should be understood that the memory can also be realized in the form of a database server or cloud storage in conjunction with the server system [106].

The processor is connected to the communication interface, allowing the computer system to communicate with remote devices (not shown in figures) such as the device [104] on the network [110]. In one scenario, the processor is configured to manage travel booking-related requests by the user [106], enabling multiple entities to utilize various functionalities described in the disclosure.

It is to be noted that the server system [106] as illustrated and hereinafter described is merely illustrative of an apparatus that could benefit from embodiments of the present disclosure and, therefore, should not be taken to limit the scope of the present disclosure.

The processor is depicted to include a first module or input/output (I/O) module [202], a second module or workflow platform module [204], a third module or fetch module [206], a fourth module or ranking module [208], a fifth module or booking module [210], a sixth module or validation module [212], a seventh module or scraper module [214], and an eighth module [216]. It should be noted that components described herein can be configured in a variety of ways, including electronic circuitries, digital arithmetic and logic blocks, and memory systems in combination with software, firmware, and embedded technologies.

The input/output (I/O) module [202] (may interchangeably be referred to as the first module [202]) includes suitable logic and/or interfaces to receive at least one travel booking-related request via at least a channel. The at least one travel booking-related request can be one or more of a new booking request, a cancellation request, an exchange request, an invoice request, and an expense logging request.

In an embodiment, the at least one travel booking can be at least one or more of air travel, ground travel, and stay/hotel booking. The air travel booking may correspond to requests related to airline tickets, including, but not limited to, seat selection, meal preferences, and additional luggage requirements. The ground travel booking may include requests related to one of car rentals, bus reservations, or other forms of ground transportation. The stay/hotel booking may correspond to requests related to lodging services, including, but not limited to, hotel reservations and special accommodation preferences.

The new booking request may correspond to a request for initiating and completing a new booking process. The cancellation request may correspond to a request for cancellation of an existing booking request. The cancellation request may include checking eligibility, applying cancellation fees, and updating booking status. The exchange request may correspond to a request for modifying an existing booking (such as changing travel dates, destinations, etc.).

The invoice request may correspond to a request for generating and sharing invoices or receipts, for record-keeping. The expense logging request may correspond to a request for documenting travel-related expenses associated with the booking. In one implementation, the invoice request may be associated with any one of new booking or existing booking. In one implementation, the expense logging request may be associated with any one of new booking or existing booking.

The channel is selected from the group consisting of email, chat box, online portal, and combinations thereof. In an embodiment, the travel booking application [112] enables the user [102] to send an email with specific booking requests to the server system [106]. In another embodiment, the user [102] may use their email server to send the email with specific booking requests to the server system [106].

In particular, the user [102] has an option to raise the travel booking-related request via a natural language. In another embodiment, the travel booking application [112] provides a chat box that enables the user [102] to perform real-time communication with the server system [106]. The user [102] can provide the travel booking-related request via the chat box. In an implementation, the travel booking application [112] may enable a virtual assistant to chat with the user [102] via the chatbot. In another implementation, the travel booking application [112] may enable a human agent to chat with the user [102] via the chatbot. The virtual chatbot may use a Generative Artificial intelligence (AI) or Generative Pre-training Transformer (GPT) model to communicate with the user [102].

In case various users wish to communicate with the virtual assistant at the same time, the server system [106] is configured to process the chat requests in a queue. The server system [106] may then process such chat requests in a First In, First Out (FIFO) manner.

In yet another embodiment, the travel booking application [112] provides an online portal to the user [102]. The user [102] can then login and submit various travel related requests directly through the online portal. In yet another embodiment, the travel booking application [112] enables the user [102] to initiate the at least one travel booking-request via one channel (e.g., chat) and receive updates or confirmations over another channel (e.g., email).

The workflow platform module [204] (may interchangeably be referred to as the second module [204]) includes suitable logic and/or interfaces to update an existing travel case or create a new travel case based on the at least one travel booking-related request received by the first module (i.e., the I/O module [202]).

In case a travel booking-related request pertains to an existing booking (such as a modification, cancellation, or addition of travel services), the workflow platform module [204] is configured to locate and update the relevant travel case in the workflow platform. This update may include adjusting booking details, updating travel dates, applying cancellation or change fees or charges, or revising the booking status.

In case of a new booking request, the workflow platform module [204] is configured to generate a new travel case. The creation of a new travel case may include assigning a unique identifier to the new case, logging details of the requested service, and initializing relevant data fields (e.g., user details, payment information, and itinerary specifics).

In one implementation, upon receiving from at least the first module [202] the at least one travel-booking related request, at least the second module [204] that is the workflow platform module [204] identifies and extracts, via implementation of a generative artificial intelligence (AI) model, relevant data fields related to the at least one travel booking related request.

The generative AI model may employ advanced natural language processing and data extraction techniques to parse the received at least one travel booking-request.

In case the at least one travel booking-related request received is unstructured (i.e., received via the chatbot or email), the workflow platform module [204] is configured to identify the intent of the at least one travel booking-related request and extract relevant details. For example, the workflow platform module [204] is configured to identify whether the request relates to a new booking, cancellation, modification, or other travel-related request. The workflow platform module [204] may implement or run the generative AI model to identify the intent of the request. In addition, the generative AI model may classify the at least one travel booking-request, extract relevant data fields, and generate a summary of the request (i.e., the email or the communication with the chatbot).

In one implementation, the workflow platform module [204] connects with a Generative Artificial Intelligence (GenAI) based classifier. The GenAI based classifier is configured to identify the intent of the at least one travel booking-related request and extract relevant details. In addition, the GenAI based classifier is configured to generate the summary of the request.

In one example, the relevant data fields may include itinerary details for new bookings or booking identifier (ID) for cancellation.

In one implementation, the second module [204] is configured to provide various user interfaces (UIs) to various users accessing the server system [106]. In one example, the second module [204] is configured to provide the various UIs via the travel booking application [112]. In one implementation, the second module [204] is configured to organize and automate the processing of various travel requests raised by users, controlling the sequence of activities according to status, type, and stage of each request.

In one implementation, the second module [204] integrates with external systems (i.e., the third-party) to gather essential information (i.e., the one or more available options) to support travel booking, management, and processing. In an embodiment, the second module [204] is configured to call external Application Programming Interfaces (APIs) to integrate with the third-party. In one implementation, the second module [204] is configured to provide user access rights to ensure that only authorized users access specific data or perform particular functions. In a nutshell, the second module [204] is configured to manage the full lifecycle of each request, from creation through processing and output generation.

The fetch module [206] (interchangeably referred to as the third module [206]) is configured to retrieve one or more available options for the travel-booking related request from at least the third-party. In some examples, the third-party may correspond to airlines, hotels, car rental agencies, and other travel-related services.

In one implementation, when the server system [106] receives a travel booking-related request (such as a request for a new booking, change in travel dates, or cancellation request), the fetch module [206] is configured to communicate with the third-party (e.g., one or more third-party providers) to gather relevant data. For example, if the user [102] requests to book a flight, the fetch module [206] is configured to retrieve flight availability, times, prices, and airline options from integrated airline databases or global distribution systems (GDS).

In an embodiment, the third-party may include an air travel provider to provide information about available flights, airlines, pricing tiers, seat availability, and associated fees. In another embodiment, the third-party may include a ground travel provider to provide information about car rental services, bus companies, or other ground transportation options (e.g., vehicle types, rates, and availability). In yet another embodiment, the third-party may include an accommodation provider to provide information about hotel room availability, pricing, amenities, and special offers based on the location and travel dates specified in the request.

In one implementation, the fetch module [206] is configured to communicate with the third-party (e.g., third-party databases, Application Programming Interfaces (APIs), etc.) in real-time. In one implementation, the fetch module [206] is configured to identify the parameters of the at least one travel booking-related request (e.g., destination, travel dates, preferred providers, etc.) based on the input received from the I/O Module [202]. The fetch module [206] is then configured to analyze this information to fetch the one or more available options.

The ranking module [208] (interchangeably referred to as the fourth module [208]) includes suitable logic and/or interfaces to rank the retrieved one or more available options based on a profile of the user [102]. In addition, the ranking module [208] is configured to display the ranked one or more available options by the third module [206]. In one implementation, the profile of the user [102] may include user preferences, past interactions, and the like.

In one implementation, the ranking module [208] is configured to implement or run the generative AI model to analyze the profile of the user [102] (i.e., user preferences and travel history). Next, the ranking module [208] is configured to rank the retrieved one or more options based on the analysis. For example, the ranking module [208] displays each retrieved option along with a confidence score indicating the suitability of each airline and hotel choice for the user [102].

The booking module [210] (interchangeably referred to as the fifth module [210]) includes suitable logic and/or interfaces to book at least one of the displayed ranked one or more options based on user selection.

In particular, after the one or more options are ranked and displayed by the fourth module [208], the booking module [210] is configured to allow the user [102] to make a selection and proceed with booking their selected option(s). In an embodiment, the booking module [210] is configured to manage the user input for booking confirmation. In another embodiment, the booking module [210] is configured to perform backend interactions required to finalize the booking with external systems or databases (i.e., the third-party). For instance, upon user selection, the booking module [210] initiates steps to confirm availability, process payment information, and generate a booking confirmation that may be provided to the user [102] in real-time.

The validation module [212] (interchangeably referred to as the sixth module [212]) includes suitable logic and/or interfaces to validate the one or more available options retrieved by at least the third module [206], based on at least a pre-existing rule for compliance. In addition, the validation module [212] is configured to optionally, apply at least a tag to the one or more available options to indicate compliance or non-compliance.

In particular, the validation module [212] is configured to assess each retrieved option against predefined rules to ensure that the retrieved options meet specified compliance requirements. The at least one predefined rule may include various regulatory, operational, or user-specific constraints that the options must adhere to before they can be considered valid for selection or booking.

In one implementation, the server system [106] is configured to access a policy database to verify that the retrieved one or more available options comply with the predefined policies. In one implementation, the policy database stores the at least one predefined policy.

Also, upon conducting the validation, the validation module [212] is configured to apply a tag or indicator to each option, signifying its compliance status. For instance, options that meet all the relevant criteria may receive a “compliant” tag, whereas options that fail to meet one or more rules might be marked as “non-compliant.” This tagging process serves as a quick visual for users or other system modules, simplifying decision-making and ensuring that only validated, rule-compliant options are presented for final consideration to the user [102].

The scraper module [214] (interchangeably referred to as the seventh module [214]) includes suitable logic and/or interfaces to collect information related to travel disruption from at least a web-based source at a pre-defined interval. In addition, the scraper module [214] is configured to notify the user [102] about the travel disruption based on the user booking. In some examples, the pre-defined interval can be one of 1 hour, 4 hours, 12 hours, 24 hours, and the like.

In particular, the scraper module [214] is configured to autonomously monitor various online sources, such as news sites, government advisories, airport websites, and other relevant platforms, to detect updates on events that could affect travel. The travel disruption may include flight delays, cancellations, severe weather events, strikes, or other conditions that could impact a planned travel itinerary of the user [102]. In one implementation, the scraped data is processed in batches and stored in the database [108]. In particular, a snapshot of the scraped data is taken at current date and time to maintain an accurate record of the scraped data.

In addition to gathering real-time data on travel disruption, the scraper module [214] is configured to cross-reference this information with the booking details of the user [102]. In one implementation, the scraper module [214] is configured to utilize an API to check for new booking and perform proactive check based on the travel disruption data. By matching disruptions with the specific travel plans of the user [102], the scraper module [214] can determine if any of the detected disruptions are relevant to the upcoming travel schedule of the user [102]. When a match is identified, the scraper module [214] triggers a notification to alert the user [102] about the disruption. The notification may include relevant details about the nature of the disruption, potential impacts on the itinerary of the user [102], and any recommended actions or alternatives if available.

In an embodiment, the scraper module [214] is configured to collect the travel disruption data for the new bookings. In another embodiment, the scraper module [214] is configured to collect the travel disruption data for existing bookings. In case the scraper module [214] identifies any travel disruption during the trip of the user [102], the scraper module [214] issues a notification indicating the same. In an example, the travel booking application [112] may display the notification to the user [102] on the device [104]. In another example, the notification may be shared via email to the user [102].

In one implementation, the scraper module [214] is configured to access an Irregular Operations (IROPS) database to track and store the disruption data.

The eighth module [216] includes suitable logic and/or interfaces to extract information from at least the invoice and at least the expense. The eighth module [216] may implement character recognition techniques such as Optical Character Recognition (OCR), Handwritten Character Recognition (HCR), Intelligent Character Recognition (ICR), and the like, to extract information from at least the invoice and at least the expense.

In one implementation, the first module [202] is adapted to receive at least an invoice related to the booking. In one implementation, at least the invoice may be uploaded in the travel booking application [112]. Next, the eighth module [216] is configured to generate at least a log. Moreover, the eighth module [216] is configured to tag at least the log with the booking. The log may include details extracted from the invoice, such as, but not limited to, booking ID, payment amount, date, and any additional transaction-specific information.

In one implementation, the first module [202] is further adapted to receive at least an expense related to the booking. In one implementation, at least the expense may be uploaded in the travel booking application [112]. Next, the eighth module [216] is configured to generate at least a log. Moreover, the eighth module [216] is configured to tag at least the log with the booking. The expense herein may refer to costs related to the booking (e.g., receipts, etc.). For example, the expense may include costs for services, such as accommodation, transportation, meals, or other incidentals associated with the booking.

Upon receiving the expense, the eighth module [216] generates a corresponding log entry, capturing essential details such as expense type, amount, vendor information, and the date of the transaction. The log provides a structured record of expenses linked to the booking, ensuring financial tracking and facilitating future audits or budget analysis.

For example, the eighth module [216] is configured to intelligently extract data from the unstructured documents, such as receipts or invoices. The eighth module [216] is then configured to categorize the extracted data into predefined categories for easy processing and reporting. In one implementation, the eighth module [216] is configured to perform Optical Character Recognition (OCR) to intelligently extract the data. In one implementation, the eighth module [216] is configured to utilize the generative AI model to intelligently extract the data. In one implementation, the server system [106] connects with the eighth module [216] via APIs. The eighth module [216] is then configured to intelligently extract the data line by line.

In one implementation, the server system [106] may receive the invoices or expense documents in one or more formats, such as images or PDFs (e.g., scanned receipts or invoices). The server system [106] may then utilize the eighth module [216] to process such documents to assign categories to each document (for example, food, travel, accommodation, etc.).

In one implementation, any one or more of the modules (i.e., the first module to the eighth module [202-216]) are at least a single or a plurality of modules comprising at least the processor. In one implementation, any one or more of the modules [202-216] may be present remotely from the server system [106].

For uploading invoices related to past or ongoing bookings, the user [102] can access the at least one channel. For example, the user [102] may access the travel booking application [112] to capture an image or upload a digital copy of the invoice. The server system [106] may then utilize the eighth module [216] to process the uploaded invoice, log the expense, and, if required by corporate policy, submit it for approval.

In an example, a traveler (e.g., the user [102]) can request flight and hotel bookings (e.g., one-way, return, or multi-city) via email in any language or format. The booking engine interprets such requests and provides personalized itinerary options based on corporate policies, current travel advisories, and the profile (e.g., past preferences) of the traveler. The traveler can then confirm or adjust these options via email, with the server system [106] processing their feedback.

Once approved, the booking completes seamlessly through integrated flight and hotel systems (i.e., the third-party). In case the requests need extra support, such as special preferences, such requests are routed to a human agent for assistance.

Alternatively, the traveler can use a portal or mobile application (e.g., the travel booking application [112]) for bookings. The travel booking application [112] provides compliant, personalized options and initiates any required approvals, ensuring a consistent, efficient booking experience across the various channels.

In another example, a traveler (e.g., the user [102] can book flights and hotels (i.e., one-way, return, or multi-city) using a chatbot interface. The server system [106] displays personalized booking options based on corporate policies, the latest travel advisories for the destination, and the historical preferences of the user [102] saved in the user profile. If the booking request requires adherence to certain policies, a policy engine (not shown in figures) automatically initiates an approval cycle before finalizing the booking. In one implementation, the policy engine is an internal component of the validation module.

In one implementation, the server system [106] connects with a chatbot via APIs. The chatbot enables the user [102] to communicate with the server system [106].

The bookings are then completed through integrated flight and hotel systems (i.e., the third-party). For exceptional cases that requires human assistance, the sever system [106] escalates the request to a human agent for further support.

In yet another example, a traveler (e.g., the user [102]) can request cancellations for flights and hotels (one-way, return, or multi-city) via email in any language or format. The server system [106] processes these requests according to corporate policies, notifying travelers about the status of the cancellation and any applicable refunds. If a policy-based approval is required, the server system [106] automatically initiates an approval cycle before proceeding with the cancellation.

In yet another example, a traveler (e.g., the user [102]) can cancel flights and hotels (one-way, return, or multi-city) through the travel booking application [112]. The server system [106] is configured to manage cancellations in compliance with corporate policies, notifying travelers about any applicable refunds. If corporate policies require approval, the server system [106] automatically initiates an approval cycle via the policy engine before completing the cancellation.

In yet another example, a traveler (e.g., the user [102]) can cancel flights and hotels (one-way, return, or multi-city) via a chatbot. The server system [106] processes cancellations in accordance with corporate policies, providing travelers with details about applicable refunds. Through the chatbot, the traveler can confirm or withdraw the cancellation request.

In yet another example, a traveler (e.g., the user [102]) can request an exchange for flights and hotels (one-way, return, or multi-city) via email in any language or format. The server system [106] processes these requests based on corporate policies, current travel advisories for the destination, and the past preferences of the user [102]. The user [102] can then confirm or modify exchange details through email, with the server system [106]. If an approval is needed, the policy engine triggers an automatic approval cycle before processing the exchange.

In yet another example, a traveler (e.g., the user [102]) can exchange flights and hotels (one-way, return, or multi-city) via the travel booking application [112]. The server system [106] processes exchanges, adhering to corporate policies and current travel advisory of the destination.

In yet another example, a traveler (e.g., the user [102]) can exchange flights and hotels (one-way, return, or multi-city) via a chatbot. The server system [106] processes exchanges, ensuring compliance with corporate policies and current travel advisory of the destination.

In yet another example, a traveler (e.g., the user [102]) can request for invoices for past or ongoing bookings via the at least one channel (i.e., through email (in any language or format), the travel booking application [112], a chatbot, etc.). The server system [106] then retrieves the relevant booking details to process these invoice requests efficiently.

FIG. 3 illustrates a flowchart [300] of a method for managing travel booking-related requests, in accordance with an embodiment of the present disclosure.

The flowchart [300] initiates at step [302].

Following step [302], at step [304], the method includes receiving by the server system [106] at least one travel booking-related request via at least the channel. The at least one travel booking related request can be one or more of a new booking request, a cancellation request, an exchange request, an invoice request, and an expense request. The at least one travel booking can be at least one or more of air travel, ground travel, and stay/hotel booking. The channel is selected from the group consisting of email, chat box, online portal, and combinations thereof.

In addition, the method, upon receiving by the server system [106] the at least one travel booking related request, includes identifying and extracting by the server system [106] via implementation of a generative artificial intelligence (AI) model, relevant data fields related to the at least one travel booking related request. In case the user [102] wants to connect with a manual agent, the server system [106] is configured to enable the user [102] to connect with the manual agent using the chatbot interface. In one implementation, the server system [106] is configured to enable the user [102] to communicate with the manual agent via an agent portal.

At step [306], the method includes updating the existing travel case or creating a new travel case by the server system [106] on the workflow platform based on the at least one travel booking-related request received by the server system [106].

At step [308], the method includes retrieving by the server system [106] one or more available options for the travel booking-related request from at least the third-party.

The method, upon retrieving by the server system [106] the one or more available options, includes validating the one or more available options by the server system [106] based on at least the pre-existing rule for compliance. In addition, the method includes optionally, applying by the server system [106], at least a tag to the one or more available options to indicate compliance or non-compliance.

At step [310], the method includes ranking and displaying by the server system [106] the retrieved one or more available options based on the profile of the user [102]. Moreover, the method includes booking by the server system [106] at least one of the retrieved options based on user selection.

The method also includes scraping by the server system [106] at least a web-based source at a pre-defined interval to collect information related to travel disruption. Further, the method includes notifying by the server system [106] the user about disruption based on user booking.

Moreover, the method includes receiving by the server system [106] at least an invoice related to the booking and generating at least a log. Next, the method includes tagging by the server system [106] the at least the log with the booking.

Also, the method includes receiving by the server system [106] at least an expense related to the booking and generating at least a log. Next, the method includes tagging by the server system [106] the at least the log with the booking.

The flowchart [300] terminates at step [312]. It is noted that one or more steps of the method are executed by at least one processor comprising at least one module (e.g., the modules [202-216]).

Although the disclosure is described herein to be implemented by the server system [106], the present disclosure encompasses that the some or all of the inventive features of the disclosure may be implemented in the device [104].

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

I/We claim:

1. A method for managing travel booking-related requests by a user [102], said method comprising:
receiving by a server system [106] at least one travel booking-related request via at least a channel;
updating an existing travel case or creating a new travel case by the server system [106] on a workflow platform based on the at least one travel booking-related request received by the server system [106];
retrieving by the server system [106] one or more available options for the travel booking-related request from at least a third-party; and
ranking and displaying by the server system [106] the retrieved one or more available options based on a profile of the user [102].

2. The method as claimed in claim 1, wherein the method comprises booking by the server system [106] at least one of the retrieved options based on user selection.

3. The method as claimed in claim 1, wherein the at least one travel booking related request can be one or more of a new booking request, a cancellation request, an exchange request, an invoice request, and an expense request.

4. The method as claimed in claim 3, wherein the at least one travel booking can be at least one or more of air travel, ground travel, and stay/hotel booking.

5. The method as claimed in claim 1, wherein the channel is selected from the group consisting of email, chat box, online portal, and combinations thereof.

6. The method as claimed in claim 1, wherein the method, upon receiving by the server system [106] the at least one travel booking related request, comprises identifying and extracting by the server system [106] via implementation of a generative artificial intelligence (AI) model, relevant data fields related to the at least one travel booking related request.

7. The method as claimed in claim 1, wherein the method, upon retrieving by the server system [106] the one or more available options, comprises validating the one or more available options by the server system [106] based on at least a pre-existing rule for compliance; and optionally, applying by the server system [106], at least a tag to the one or more available options to indicate compliance or non-compliance.

8. The method as claimed in claim 2, wherein the method comprises scraping by the server system [106] at least a web-based source at a pre-defined interval to collect information related to travel disruption; and notifying the user [102] about disruption based on user booking.

9. The method as claimed in claim 2, wherein the method comprises generating by the server system [106] at least a log; and tagging by the server system [106] the at least the log with the booking.

10. The method as claimed in claim 1, wherein one or more steps of the method are executed by at least one processor comprising at least one module.

11. A system for managing travel booking-related requests by a user [102], said system comprising:
a server system [106], said server system [106] comprising at least a first module [202] that is an input/output (I/O) module [202] to receive least one travel booking-related request via at least a channel;
at least a second module [204] that is a workflow platform module [204] to update an existing travel case or create a new travel case based on the at least one travel booking-related request received by the first module [202];
at least a third module [206] that is a fetch module [206] to retrieve one or more available options for the travel booking-related request from at least a third-party; and
at least a fourth module [208] that is a ranking module [208] to rank the retrieved one or more options based on a profile of the user [102], and display the ranked one or more available options by the third module [206].

12. The system as claimed in claim 11, wherein the server system [106] comprises at least a fifth module [210] that is a booking module [210] to book at least one of the displayed ranked one or more options based on user selection.

13. The system as claimed in claim 11, wherein the at least one travel booking-related request can be one or more of a new booking request, a cancellation request, an exchange request, an invoice request, and an expense logging request.

14. The system as claimed in claim 13, wherein the at least one travel booking can be at least one or more of air travel, ground travel, and stay/hotel booking.

15. The system as claimed in claim 11, wherein the channel is selected from the group consisting of email, chat box, online portal, and combinations thereof.

16. The system as claimed in claim 11, wherein at least the second module [204] that is the workflow platform module [204], upon receiving from at least the first module [202] the at least one travel-booking related request, identifies and extracts, via implementation of a generative artificial intelligence (AI) model, relevant data fields related to the at least one travel booking related request.

17. The system as claimed in claim 11, wherein the server system [106] comprises at least a sixth module [212] that is a validation module [212] to validate the one or more available options retrieved by at least the third module [206], based on at least a pre-existing rule for compliance; and optionally, apply at least a tag to the one or more available options to indicate compliance or non-compliance.

18. The system as claimed in claim 12, wherein the server system [106] comprises at least a seventh module [214] that is a scraper module [214] to collect information related to travel disruption from at least a web-based source at a pre-defined interval; and notify the user [102] about the travel disruption based on user booking.

19. The system as claimed in claim 12, wherein the server system [106] comprises at least an eighth module [216] configured to generate at least a log; and tag at least the log with the booking.

20. The system as claimed in claim 11, wherein any one or more of the modules [202-216] are at least a single or a plurality of modules comprising at least a processor.
